(19) United States
(12) Patent Application Publication
(10) Pub. No.: US 2024/0326572 A1
(43) Pub. Date: Oct. 3, 2024

(54) MOUNTING RUBBER MEMBER

(71) Applicant: Sumitomo Riko Company Limited, Aichi (JP)

(72) Inventors: Hiroki Mizukawa, Aichi (JP); Naoki Furumachi, Aichi (JP)

(73) Assignee: Sumitomo Riko Company Limited, Aichi (JP)

(21) Appl. No.: 18/406,230

(22) Filed: Jan. 8, 2024

(30) Foreign Application Priority Data
Mar. 29, 2023 (JP) 2023-053273

(51) Int. Cl. B60K 5/12; F16F 15/08

(52) U.S. Cl. CPC B60K 5/1208; F16F 15/08

(57) ABSTRACT

A mounting rubber member for a vehicle, which is mounted to a surface of a mounting target member of a vehicle, includes a mounting shaft part that protrudes toward a mounting direction from a mounting surface to the mounting target member and is inserted into a mounting hole of the mounting target member. The mounting shaft part includes a neck part that is to be positioned inside the mounting hole of the mounting target member. The mounting shaft part includes, in a circumferential direction, locking parts that protrude on an outer circumferential surface and are locked to a back surface at a portion that protrudes from the mounting hole of the mounting target member to a back surface side. The neck part is formed with a groove-shaped recess that extends in the circumferential direction on a base side of the locking part.

### CROSS-REFERENCE TO RELATED APPLICATION

This application claims the priority benefit of Japan application serial no. 2023-053273, filed on Mar. 29, 2023. The entirety of the above-mentioned patent application is hereby incorporated by reference herein and made a part of this specification.

### BACKGROUND

### Technical Field

The disclosure relates to a mounting rubber member such as a heat insulator and a stopper rubber to be mounted to a surface of a mounting target member in a vehicle.

### Related Art

Conventionally, in vehicles such as automobiles, it is common to mount a separate mounting rubber member to a member surface. Specifically, for example, a stopper rubber serves to buffer and restrict a relative displacement amount between members in a vibrating member such as a power unit and a swinging member such as a suspension arm, and a heat insulator serves to protect a vibration damping device from heat of an engine. Japanese Patent Application Laid-Open No. 2005-249062 (Patent Document 1) shows a bound stopper (stopper rubber) as an example of such a mounting rubber member.

In a vehicle such as an automobile, it is necessary to securely mount a mounting rubber member to a mounting target member to avoid dropout due to vibration during traveling, and it is also difficult to adopt a troublesome process such as adhesion. Thus, as described in Patent Document 1 above, a structure has been proposed in which a rubber protrusion to be inserted into a fitting hole formed at the mounting target member is integrally formed at the mounting rubber member, and an umbrella-shaped coming-off prevention part provided at the rubber protrusion is locked to an opening edge of the fitting hole on a back surface of the mounting target member. In such a locking structure, a mounting worker may turn his or her hand to the back surface side of the mounting target member and pull a tip of the rubber protrusion inserted into the fitting hole toward the back surface side to pull out the umbrella-shaped coming-off prevention part from the fitting hole of the mounting target member to the back surface side and lock the umbrella-shaped coming-off prevention part.

However, for structure-related reasons or manufacturing-related reasons of the vehicle, it may be difficult to mount the mounting rubber member to the mounting target member in advance. Further, since a mounting space for various members is limited in a vehicle, it may be difficult to turn one's hand and work on the back surface side of the mounting target member, especially in a state where the mounting target member has been assembled to a unit or a vehicle main body.

Furthermore, it has been considered to press and push such a rubber protrusion from the surface side into the fitting hole of the mounting target member. However, it is difficult to even press the coming-off prevention part, which spreads in an umbrella shape, from the surface side into the fitting hole, and even if the coming-off prevention part could be inserted into the fitting hole from the surface side, it is extremely difficult to move the coming-off prevention part within the fitting hole and lock to the back surface side, due to a large frictional resistance caused by the strong pressing of the coming-off prevention part against an inner circumferential surface of the fitting hole.

Thus, in a vehicle such as an automobile, it is difficult in some cases to mount a mounting rubber member to a mounting target member with a locking structure involving a rubber protrusion of a conventional structure as described in Patent Document 1.

### SUMMARY

The following describes exemplary aspects for understanding the disclosure, but the aspects described below are illustrative and may be adopted in combination with each other as appropriate. Also, components described in the aspects may be recognized and adopted independently wherever possible, and may be adopted in combination with any of components described in other aspects as appropriate. Thus, various other aspects may be realized in the disclosure without being limited to the aspects described below.

A first aspect is a mounting rubber member for a vehicle, which is mounted to a surface of a mounting target member of a vehicle. The mounting rubber member for a vehicle includes a mounting shaft part that protrudes toward a mounting direction from a mounting surface overlapped with the surface of the mounting target member and is inserted into a mounting hole of the mounting target member. The mounting shaft part includes a neck part that is to be positioned inside the mounting hole of the mounting target member. The mounting shaft part includes, in a circumferential direction, a plurality of locking parts that protrude on an outer circumferential surface and are locked to a back surface at a portion that protrudes from the mounting hole of the mounting target member to a back surface side. The neck part is formed with a groove-shaped recess that extends in the circumferential direction on a base side of the locking part.

According to the mounting rubber member for a vehicle configured according to this aspect, when the locking part of the mounting shaft part passes through the mounting hole, by allowing deformation of the locking part entering into the groove-shaped recess, an increase in spring constant due to compression of the locking part is suppressed, and the resistance is reduced when inserting the mounting shaft part into the mounting hole. Thus, for example, even in the case of pressing and inserting the mounting shaft part into the mounting hole, it is possible to more easily insert the mounting shaft part into the mounting hole, and it becomes easy to mount the mounting rubber member to the mounting target member.

Further, since the plurality of locking parts protruding at the mounting shaft part are provided partially in the circumferential direction, compared to the case where the locking part is continuous over the entire circumference, deformation of entering into the groove-shaped recess on the insertion base side is more likely to occur, and the resistance during insertion into the mounting hole is further reduced. Moreover, since an increase in spring due to compression of the plurality of locking parts is also suppressed by bulging deformation to an in-between space in the circumferential direction, the resistance during insertion is further reduced.

A second aspect is the mounting rubber member for a vehicle according to the first aspect, in which the groove-shaped recess is continuously provided over an entire circumference.

According to the mounting rubber member configured according to this aspect, since the locking part which has deformed to enter into the groove-shaped recess during passage through the mounting hole is also allowed to deform in the circumferential direction within the groove-shaped recess, the resistance during insertion is further reduced, and the insertion work becomes easy.

A third aspect is the mounting rubber member for a vehicle according to the first or second aspect, in which a portion of the neck part that is off the groove-shaped recess in the mounting shaft part has a diameter larger than that of an insertion tip part located on a tip side of the locking part.

According to the mounting rubber member configured according to this aspect, it is possible to reduce the gap between the outer circumferential surface of the portion of the neck part off the groove-shaped recess in the mounting shaft part and the inner circumferential surface of the mounting hole to prevent looseness of the rubber member against the mounting target member. Further, by configuring the insertion tip part of the mounting shaft part to have a diameter smaller than that of the portion of the neck part off the groove-shaped recess, it becomes easy to insert the insertion tip part into the mounting hole, and it becomes easy to position the rubber member to an assembly position with respect to the mounting target member.

A fourth aspect is the mounting rubber member for a vehicle according to one of the first to third aspects, in which in a longitudinal section at a position at which the locking part is provided, an area of the groove-shaped recess that is recessed toward an inner circumference more inward than the mounting hole is set to be 60% or more of an area of a portion of the locking part that protrudes toward an outer circumference more outward than the mounting hole.

According to the mounting rubber member configured according to this aspect, when the locking part passes through the mounting hole, entrance of the locking part into the groove-shaped recess is sufficiently allowed, and the insertion resistance is effectively reduced.

A fifth aspect is the mounting rubber member for a vehicle according to one of the first to fourth aspects, in which a groove width dimension of the groove-shaped recess is set within a range of 60 to 150% with respect to a protrusion height dimension of the locking part from the outer circumferential surface of the mounting shaft part.

According to the mounting rubber member configured according to this aspect, when the locking part passes through the mounting hole, it is possible to sufficiently allow the locking part to deform to fall and enter into the groove-shaped recess.

A sixth aspect is the mounting rubber member for a vehicle according to one the first to fifth aspects, in which a pressing operation part to which an external force for inserting the mounting shaft part into the mounting hole is applied is integrally formed on an axial extension of the mounting shaft part on a base side of the mounting shaft part.

According to the mounting rubber member configured according to this aspect, an external force for pressing the mounting shaft part into the mounting hole is efficiently applied from the pressing operation part to the mounting shaft part, so it is less likely for unintended displacement such as tilting of the rubber member to occur, and it becomes possible to stably mount the rubber member to the mounting target member.

According to the aspects the disclosure, it is possible to press and insert the mounting shaft part into the mounting hole of the mounting target member to easily mount to the mounting target member.

### BRIEF DESCRIPTION OF DRAWINGS

FIG. 1 is a perspective view of a heat insulator according to a first embodiment of the disclosure.

FIG. 2 is a perspective view of the heat insulator shown in FIG. 1 from a different angle.

FIG. 3 is a left side view of the heat insulator shown in FIG. 1.

FIG. 4 is a cross-sectional view taken along line IV-IV in FIG. 3.

FIG. 5 is a cross-sectional view taken along line V-V in FIG. 4.

FIG. 6 is a perspective view of an engine mount including the heat insulator shown in FIG. 1.

FIG. 7 is a front view of the engine mount shown in FIG. 6.

FIG. 8 is a right side view of the engine mount shown in FIG. 6.

FIG. 9 is an enlarged cross-sectional view showing a mounting portion of the heat insulator in the engine mount shown in FIG. 6, and is a view corresponding to line IX-IX in FIG. 10.

FIG. 10 is a cross-sectional view taken along line X-X in FIG. 9.

FIG. 11A is a cross-sectional view of a main part illustrating an assembly process of the heat insulator shown in FIG. 1 to a mount main body shown in FIG. 8, showing a state in which an insertion tip part of a mounting shaft part is inserted into a mounting hole.

FIG. 11B is a cross-sectional view of the main part illustrating the assembly process of the heat insulator shown in FIG. 1 to the mount main body shown in FIG. 8, showing a state in which a guide surface of a locking part of the mounting shaft part abuts against an opening edge of the mounting hole.

FIG. 11C is a cross-sectional view of the main part illustrating the assembly process of the heat insulator shown in FIG. 1 to the mount main body shown in FIG. 8, showing a state in which a tip portion of the locking part of the mounting shaft part is inserted into the mounting hole.

FIG. 11D is a cross-sectional view of the main part illustrating the assembly process of the heat insulator shown in FIG. 1 to the mount main body shown in FIG. 8, showing a state in which a base portion of the locking part of the mounting shaft part is inserted into the mounting hole.

### DESCRIPTION OF EMBODIMENTS

Embodiments of the disclosure provide a rubber member of a novel structure in which, by enabling pressing and inserting a mounting shaft part into a mounting hole of a mounting target member, the rubber member can be easily mounted to the mounting target member even in a situation where it is difficult to perform a work such as pulling the mounting shaft part from a back surface side of the mounting target member.

Hereinafter, embodiments of the disclosure will be described with reference to the drawings.

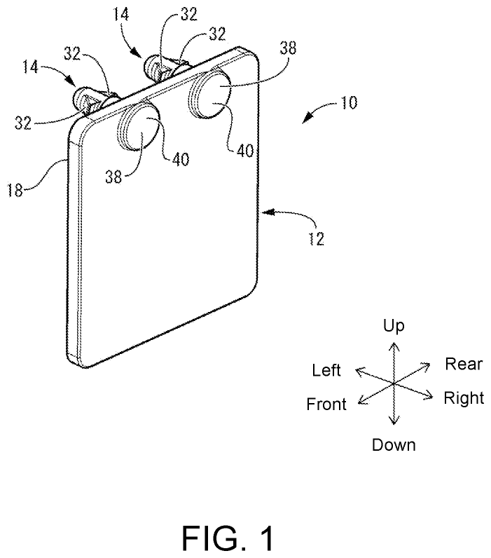

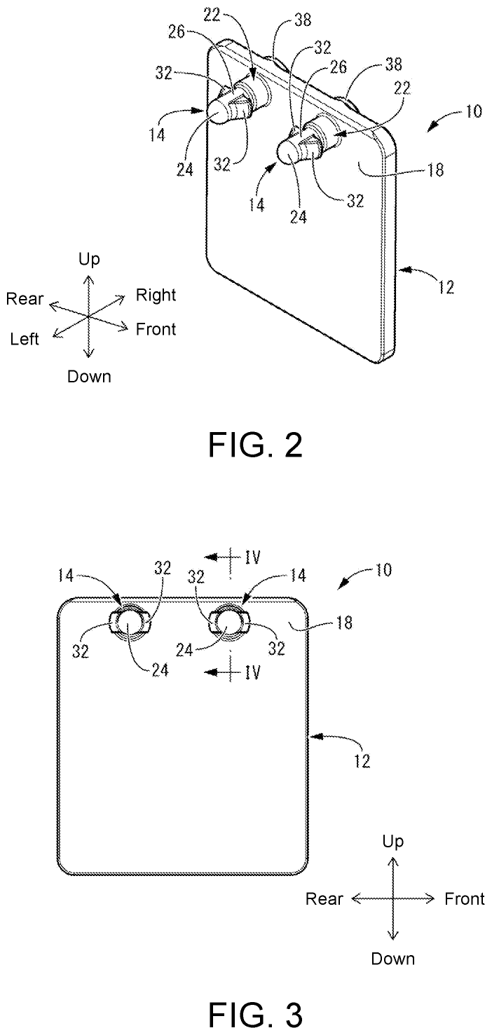

FIG. 1 to FIG. 3 show a heat insulator 10 for a vibration damping device in an automobile as a first embodiment of a mounting rubber member for a vehicle configured according to the disclosure. The heat insulator 10 is formed of a rubbery elastic body (including rubber and resin elastomer) as a whole, and includes a main body part 12 in a plate shape and two mounting shaft parts 14 and 14 protruding toward the left from the main body part 12. In the following description, in principle, an “up-down direction” refers to an up-down direction in FIG. 3, a “front-rear direction” refers to a left-right direction in FIG. 3, and a “left-right direction” refers to a direction orthogonal to a paper surface in FIG. 3.

The main body part 12 has a substantially rounded-corner rectangular shape with corners that are rounded in a left-right direction view, and has a flat plate shape with a substantially constant thickness dimension as a whole. A left-side surface at an upper part of the main body part 12 is formed as a mounting surface 18 that expands in a direction substantially orthogonal to the left-right direction.

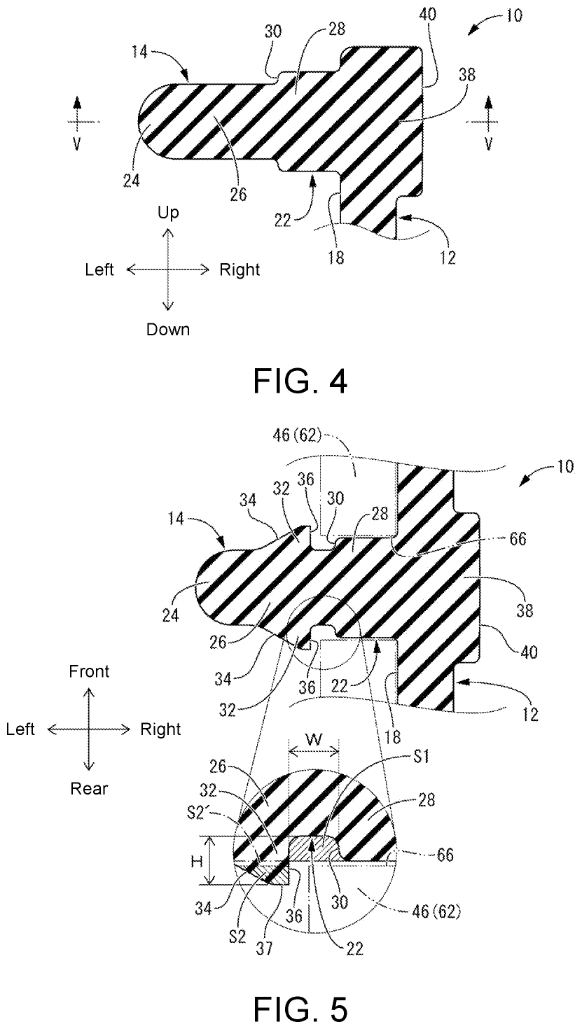

As shown in FIG. 4 and FIG. 5 as well, the mounting shaft part 14 has a small-diameter circular rod shape as a whole, and integrally includes a neck part 22 that protrudes to the left from the mounting surface 18 of the main body part 12 to form a base part, an insertion tip part 24 that forms a tip part, and an intermediate part 26 that connects the neck part 22 and the insertion tip part 24 to each other.

A base portion of the neck part 22 forms a positioning part 28 corresponding to a mounting hole 66 formed at a vertical wall part 62 of a first mounting member 46 (to be described later). A tip portion of the neck part 22 is formed with a diameter smaller than the positioning part 28 due to a groove-shaped recess 30 that is opened toward an outer circumference and extends continuously over an entire circumference. An outer diameter dimension of the positioning part 28 may be substantially the same as an inner diameter dimension of the mounting hole 66 (to be described later), and may be suitably set within a range of 80 to 120% of the inner diameter dimension of the mounting hole 66.

The intermediate part 26 has a small-diameter cylindrical shape with an outer diameter dimension substantially the same as the tip portion of the neck part 22 at which the groove-shaped recess 30 is provided. A base of the intermediate part 26 is continuous with the neck part 22, and a tip of the intermediate part 26 is continuous with the insertion tip part 24. The insertion tip part 24 may have a tapered shape with a diameter that decreases toward a tip side, and in this embodiment, the insertion tip part 24 has a hemispherical shape, with an outer diameter dimension of a base that is substantially the same as the outer diameter dimension of the intermediate part 26.

A pair of locking parts 32 and 32 are integrally formed at the intermediate part 26 of the mounting shaft part 14. The locking parts 32 and 32 are provided to protrude toward the outer circumferential side on both sides in the front-rear direction from the intermediate part 26. A protrusion height dimension of the locking part 32 gradually increases from a tip (left end) toward a base (right end) and is maximum at the base. An end surface (left end surface) on the tip side of the locking part 32 forms a guide surface 34 that is inclined to the outer circumference toward the base. An end face (right end surface) on the base side of the locking part 32 forms a locking surface 36 that expands in a direction substantially orthogonal to the left-right direction. Thus, the locking part 32 has a longitudinal sectional shape shown in FIG. 5 that is a substantially right-angled triangular shape. In this embodiment, the locking part 32 is provided with a tubular surface 37 that extends straight in an axial direction between the guide surface 34 and the locking surface 36 at the outer circumferential surface.

The groove-shaped recess 30 of the neck part 22 is located adjacent to the base side of the locking part 32. In an embodiment, in a longitudinal section at a formation position of the locking part 32 shown in FIG. 5, a maximum protrusion height dimension H of the locking part 32 is preferably within a range of 60 to 150% with respect to a groove width dimension W of the groove-shaped recess 30, and more preferably set within a range of 80 to 120%, for example. Further, in this longitudinal section, an area S1 of a region of the groove-shaped recess 30 that is recessed toward the inner circumference from the outer circumferential surface of the positioning part 28 may be 60% or more with respect to an area S2 of a protruding tip part of the locking part 32 that protrudes toward the outer circumference from an inner surface of the mounting hole 66 (to be described later) virtually indicated by a double-dot dashed line in FIG. 5, preferably set within a range of 60 to 150%, and more preferably set within a range of 80 to 120%, for example. Further, the area (S1) of the groove-shaped recess 30 may be set larger than an area (S2′) of the locking part 32 protruding toward the outer circumference from the outer circumferential surface of the positioning part 28 at the tip side of the groove-shaped recess 30. In FIG. 5, the regions of S1 and S2 are enclosed with solid lines and applied with hatching, and the region of S2′ is enclosed with a dot-dashed line.

As shown in FIG. 4, the outer circumferential surface of the intermediate part 26 in the circumferential direction between the pair of locking parts 32 and 32 is formed with a shape and a diameter dimension obtained by extending a bottom surface of the groove-shaped recess 30 toward the tip side. Further, as shown in FIG. 5, the outer circumferential surface of the intermediate part 26 on the tip side of the pair of locking parts 32 and 32 is formed with a shape and a diameter dimension obtained by extending the bottom surface of the groove-shaped recess 30 toward the tip side. Thus, the intermediate part 26 has a diameter smaller than that of the positioning part 28 of the neck part 22 at a portion that is off the pair of locking parts 32 and 32.

The tip side of the locking part 32 in the mounting shaft part 14 is composed of a part of the intermediate part 26 and the insertion tip part 24, and is formed with a diameter smaller than that of the positioning part 28, which is a portion of the neck part 22 that is off the groove-shaped recess 30. In other words, the positioning part 28 of the neck part 22 is formed with a diameter larger than the tip side of the locking part 32 in the mounting shaft part 14.

A portion located on an extension toward the base side of the mounting shaft part 14 in the main body part 12 is formed as a pressing operation part 38. The pressing operation part 38 is provided at an upper end part of the main body part 12. The pressing operation part 38 has an input surface 40 that expands orthogonally with respect to the left-right direction, and the input surface 40 has a substantially circular shape in a right side view (see FIG. 1). A center of the input surface 40 may be located on an extension of a central axis of the mounting shaft part 14. In this embodiment, the input surface 40 is formed with a diameter larger than that of the mounting shaft part 14. However, the input surface 40 may also have the same diameter or a diameter smaller than that of the mounting shaft part 14. In this embodiment, the pressing operation part 38 is provided on the extension in the axial direction toward the base side of each of the two mounting shaft parts 14 and 14.

Considering the transmission pattern of a pressing reaction force from the mounting shaft part 14, the pressing operation part 38 may be located on the extension of the central axis of the mounting shaft part 14 and may be one size larger than the cross-section of the mounting shaft part 14. Furthermore, considering the pressing operability, the pressing operation part 38 is not overly large, so a worker can accurately recognize the position of the mounting shaft part 14 which is difficult to see. Thus, the pressing operation part 38 may be formed into a shape that protrudes from a surface side of the main body part 12 of the heat insulator 10 to be visually recognizable and/or recognizable by touch, and may have a pressing tip surface (input surface 40) of a size of 100 to 300% of a cross-sectional area of the mounting shaft part 14.

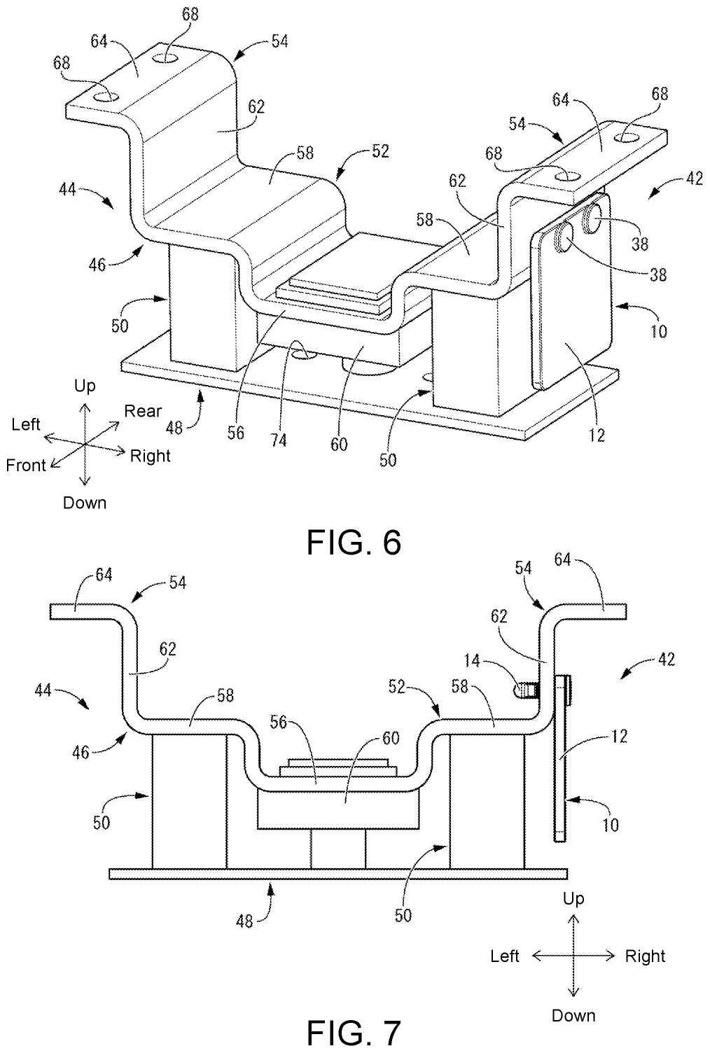

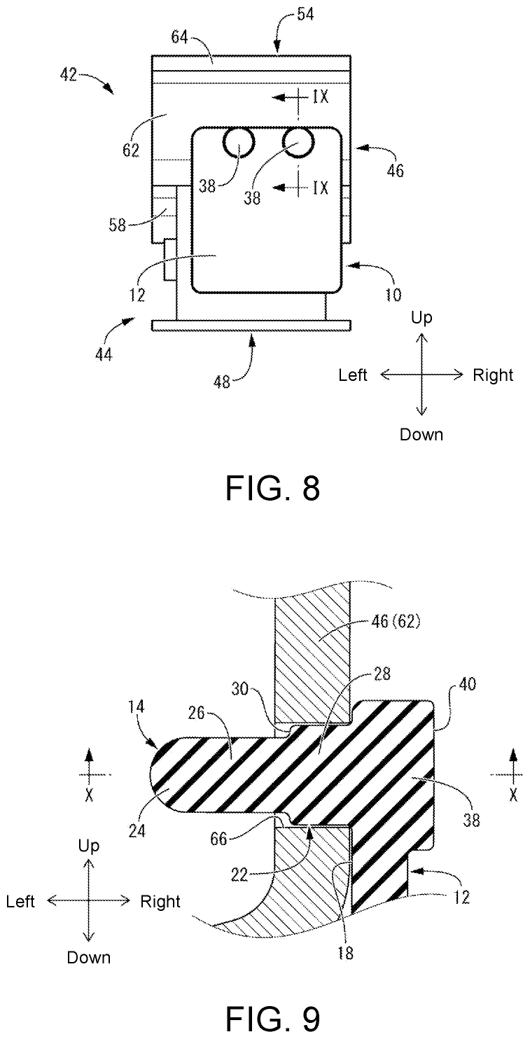

As shown in FIG. 6 to FIG. 8, the heat insulator 10 is a component of an engine mount 42. The engine mount 42 has a structure in which the heat insulator 10 is mounted to a mount main body 44. The mount main body 44 has a structure in which a first mounting member 46 and a second mounting member 48 are connected to each other by a pair of connecting rubbers 50 and 50.

The first mounting member 46 is a plate-shaped member formed of a hard material such as metal (e.g., iron) and fiber-reinforced resin, and the first mounting member 46 is longer in the left-right direction than in the front-rear direction. An intermediate portion in the left-right direction of the first mounting member 46 forms a connection part 52 that expands in a direction crossing the up-down direction, and both end portions in the left-right direction of the first mounting member 46 form mounting parts 54 and 54 that extend upward.

A central portion in the left-right direction of the connection part 52 forms a stopper configuration part 56 that expands in a direction substantially orthogonal to the up-down direction, and left and right outer portions of the stopper configuration part 56 in the connection part 52 form rubber fixing parts 58 and 58 that are located higher than the stopper configuration part 56 and are inclined upward toward the left and right outer sides. A stopper rubber 60 is fixed to a lower surface of the stopper configuration part 56, and an approaching displacement amount in the up-down direction between the first mounting member 46 and the second mounting member 48 is restricted by abutment via the stopper rubber 60.

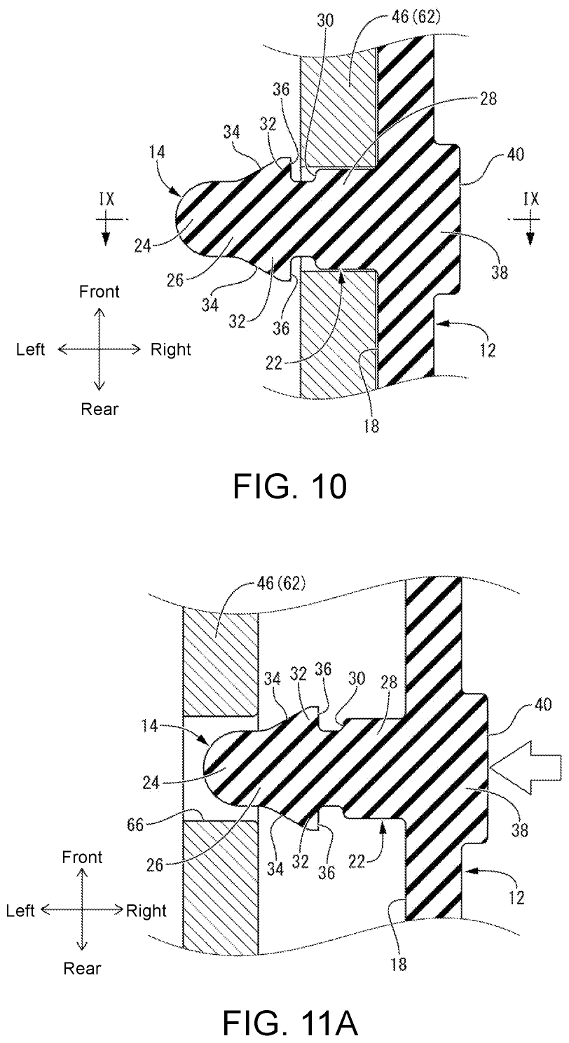

The mounting part 54 is provided with a vertical wall part 62 that extends upward from the rubber fixing part 58 of the connection part 52, and a first fastening part 64 that bends and expands to the left and right outer sides is provided at an upper end of the vertical wall part 62. As shown in FIG. 9 and FIG. 10, a mounting hole 66 that penetrates in the left-right direction, which is a thickness direction, is formed at the right-side vertical wall part 62. In this embodiment, the mounting hole 66 is a small-diameter circular hole and is provided as two mounting holes 66 at positions separated from each other in the front-rear direction. Further, as shown in FIG. 6, two first bolt holes 68 and 68 that penetrate in the up-down direction are formed at each first fastening part 64 at positions separated from each other in the front-rear direction. Then, the first mounting member 46 is bolt-fixed to a power unit (not shown) using the first bolt holes 68 of the first fastening parts 64.

The second mounting member 48 is a plate-shaped member formed of a metal material or the like similar to the first mounting member 46, and, as shown in FIG. 6 to FIG. 8, has a substantially flat plate shape that is longer in the left-right direction than in the front-rear direction. A plurality of second bolt holes 74 penetrating in the up-down direction are formed at a left-right intermediate portion of the second mounting member 48. The second mounting member 48 is bolt-fixed to a vehicle body (not shown) using the second bolt holes 74.

The first mounting member 46 is arranged to be located above and oppose to the second mounting member 48 with a gap therebetween, and the first mounting member 46 and the second mounting member 48 are connected to each other by a pair of connecting rubbers 50 and 50. The connecting rubber 50 has a substantially rectangular block shape as a whole and extends in the up-down direction. An upper end surface of the connecting rubber 50 is fixed to a lower surface of the rubber fixing part 58 of the first mounting member 46, and a lower end surface of the connecting rubber 50 is fixed to an upper surface of left-right end parts of the second mounting member 48.

The heat insulator 10 is mounted to the first mounting member 46 of the mount main body 44. That is, in the heat insulator 10, the mounting surface 18 of the main body part 12 is overlapped with a right-side surface, which is a surface of the right-side vertical wall part 62, of the first mounting member 46. Then, as shown in FIG. 9 and FIG. 10, by inserting each mounting shaft part 14 of the heat insulator 10 into each mounting hole 66 provided at the vertical wall part 62 of the first mounting member 46 of the mount main body 44, the heat insulator 10 is mounted to the mount main body 44. The mounting shaft part 14 protrudes toward the left side, which is a mounting direction of the heat insulator 10 from the mounting surface 18 of the main body part 12 to the vertical wall part 62. In this embodiment, the mounting target member, which is an attachment target of the heat insulator 10, is constituted by the first mounting member 46.

With the heat insulator 10 mounted to the vertical wall part 62 of the first mounting member 46, the mounting shaft parts 14 and 14 are inserted through the mounting holes 66 and 66 from the right side, which is a surface side, to the left side, which is a back side, and protrude to the left side of the vertical wall part 62. In the attached state of the heat insulator 10 to the vertical wall part 62, the neck part 22 of the mounting shaft part 14 is located inside the mounting hole 66. Further, the locking parts 32 and 32 of the mounting shaft part 14 pass through the mounting hole 66 and are located on the left side of the vertical wall part 62, and the locking surfaces 36 and 36 of the locking parts 32 and 32 are overlapped with the left-side surface, which is the back surface, of the right-side vertical wall part 62 in an abutment state or in an opposing state with a gap therebetween. Accordingly, coming-off of the mounting shaft part 14 from the mounting hole 66 is prevented by locking between the locking part 32 and the vertical wall part 62, and dropout of the heat insulator 10 from the first mounting member 46 is prevented.

The mounting shaft parts 14 and 14 of the heat insulator 10 are inserted through the mounting holes 66 and 66 of the vertical wall part 62 in the mount main body 44 by pressing from the base side toward the tip side, such that the mounting shaft parts 14 and 14 are inserted from the surface-side opening and protrude from the back-side opening. In this embodiment, since the pressing operation part 38 is provided on an extension of each mounting shaft part 14 toward the base side, by applying a pressing force in a direction perpendicular to the plane of the input surface 40 of each pressing operation part 38, an external force in the pressing direction can efficiently act on the mounting shaft parts 14 and 14, and the mounting shaft parts 14 and 14 can be inserted into the mounting holes 66 and 66 with a relatively small input.

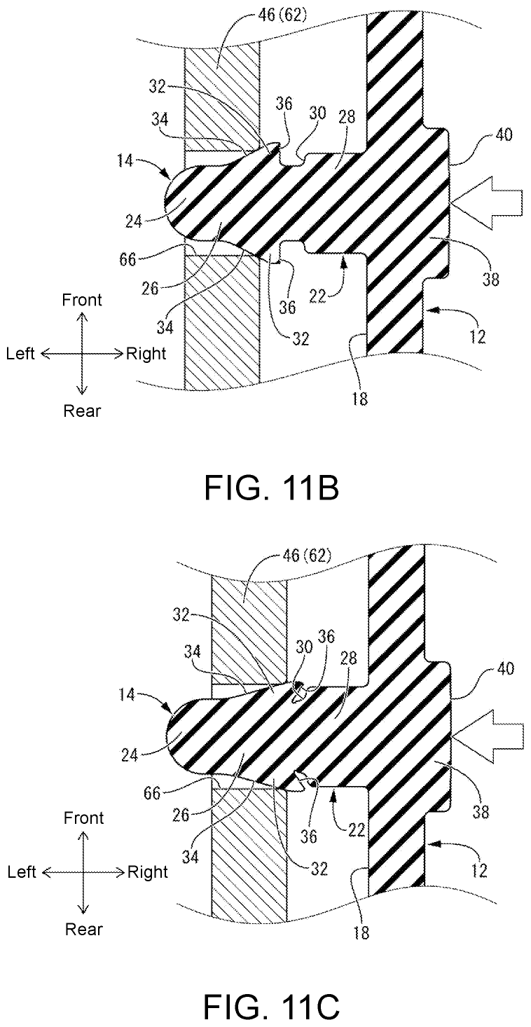

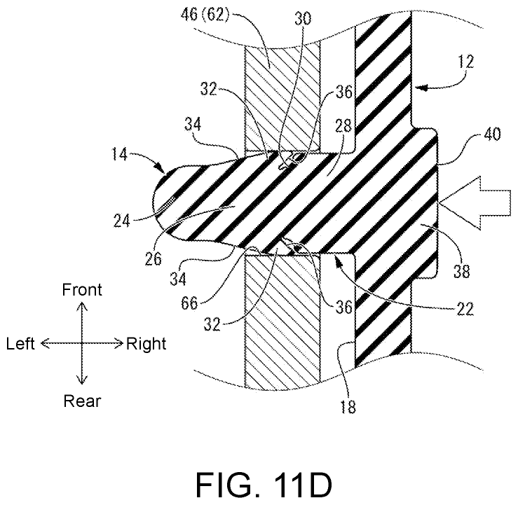

In such insertion of the mounting shaft part 14 into the mounting hole 66 by pressing, the resistance force is likely to become an issue when the locking part 32 passes through the mounting hole 66. However, the groove-shaped recess 30 is provided on the base side of the locking part 32, and, as shown in FIG. 11A to FIG. 11D, since deformation for the locking part 32 to enter into the groove-shaped recess 30 is allowed, the resistance force is reduced when the locking part 32 passes through the mounting hole 66.

That is, first, as shown in FIG. 11A, the insertion tip part 24 of the mounting shaft part 14 is inserted into the mounting hole 66. Since the insertion tip part 24 has a diameter smaller than that of the mounting hole 66, the insertion tip part 24 can be easily inserted into the mounting hole 66. By inserting the insertion tip part 24 into the mounting hole 66 in this manner, the mounting shaft part 14 can be easily positioned with respect to the mounting hole 66 to facilitate insertion by a pressing operation to be described later.

As the mounting shaft part 14 is inserted into the mounting hole 66, as shown in FIG. 11B, each guide surface 34 located on the tip side of the locking parts 32 and 32 abuts against an opening edge of the mounting hole 66. Until the locking parts 32 and 32 abut against the mounting hole 66, there is a gap between the mounting shaft part 14 and the mounting hole 66, which allows easy insertion.

Next, as the mounting shaft part 14 is inserted further into the mounting hole 66, since a reaction force of abutment with the mounting hole 66 acts on the guide surface 34 of each locking part 32, as shown in FIG. 11C and FIG. 11D, while deforming to fall toward the base side, the locking parts 32 and 32 are pressed into the mounting hole 66.

Since the locking parts 32 and 32 are pressed against the inner circumferential surface of the mounting hole 66 by elasticity, in the state of FIG. 11C and FIG. 11D, a resistance force acts against insertion of the mounting shaft part 14 into the mounting hole 66. An external force for pressing the mounting shaft part 14 into the mounting hole 66 against this resistance force is applied to the input surface 40 of the pressing operation part 38. Since the input surface 40 of the pressing operation part 38 is provided on an extension on an opposite side of the insertion direction in which the mounting shaft part 14 is inserted into the mounting hole 66, by applying an external force to the input surface 40 in the insertion direction, the mounting shaft part 14 can be efficiently pressed into the mounting hole 66.

In FIG. 11C and FIG. 11D, each locking surface 36 of the locking parts 32 and 32 is inclined to the right side, which is an insertion base side, toward the outer circumference, and the protrusion height of the locking parts 32 and 32 toward the outer circumference is reduced. By deforming to fall toward the groove-shaped recess 30 side, the locking parts 32 and 32 enter into the groove-shaped recess 30. Thus, by providing the groove-shaped recess 30 adjacent to the base side of the locking parts 32 and 32, falling deformation of the locking parts 32 and 32 is allowed, and it is possible to prevent a significant increase in the resistance force against pressing of the mounting shaft part 14 into the mounting hole 66 due to a sudden increase in spring resulting from compression of the locking parts 32 and 32. Thus, it is possible to press and insert the mounting shaft part 14, which is provided with the locking parts 32 and 32 protruding to the outer circumference more outward than the mounting hole 66, into the mounting hole 66 with a relatively small force.

In this embodiment, since the groove-shaped recess 30 is provided in an annular shape that is continuous over the entire circumference, the locking parts 32 and 32 are allowed to deform further to both sides in the circumferential direction in a state of having fallen and entered into the groove-shaped recess 30. Thus, it is less likely for the locking parts 32 and 32 to be highly compressed during passage through the mounting hole 66, and an increase in insertion resistance due to excessive compression of the locking parts 32 and 32 is further suppressed.

Furthermore, since the locking parts 32 and 32 are partially provided in the circumferential direction, and, similar to the groove-shaped recess 30, the portion between the locking parts 32 and 32 in the circumferential direction has a diameter smaller than that of the mounting hole 66, each locking part 32 is allowed to deform not only toward the base side but also to both sides in the circumferential direction when passing through the mounting hole 66. Thus, an increase in spring due to compression of the locking parts 32 and 32 during passage through the mounting hole 66 is further suppressed, and the resistance during insertion of the mounting shaft part 14 into the mounting hole 66 is further reduced.

Next, by further pressing the mounting shaft part 14, the locking parts 32 and 32 pass through the mounting hole 66. Accordingly, deformation of the locking parts 32 and 32 due to abutment with the inner surface of the mounting hole 66 is released, and the shape is restored by the elasticity of the locking parts 32 and 32. As a result, as shown in FIG. 10, the protruding tip part (outer circumferential end) of the locking parts 32 and 32 is located on the outer circumference more outward than the mounting hole 66 and overlaps with the vertical wall part 62 in a projection in the left-right direction. Accordingly, coming-off of the mounting shaft part 14 from the mounting hole 66 to the right side is prevented by locking between the locking parts 32 and 32 and the vertical wall part 62 to keep the heat insulator 10 in the attached state without detaching from the vertical wall part 62. A distance between opposing surfaces of the mounting surface 18 of the main body part 12 and the base surface of the locking part 32 may be larger than, equal to, or smaller than a thickness dimension of the vertical wall part 62 at the opening edge of the mounting hole 66, and is larger than the thickness dimension of the vertical wall part 62 in this embodiment. Further, in the attached state of the heat insulator 10 to the vertical wall part 62, the back surface of the heat insulator 10 and the surface of the vertical wall part 62 overlap with each other, and may abut against each other to overlap in a substantially close contact state, may overlap with a gap therebetween, or may overlap with another member such as a spacer, a secondary cushioning material, and a positioning auxiliary material interposed therebetween.

In the locking part 32, by providing the tubular surface 37 extending straight in the axial direction at a protruding tip surface, deformation rigidity of the protruding tip portion locked to the vertical wall part 62 is adjusted. Thus, by adjusting the length of the tubular surface 37, it is also possible to adjust the balance between ease of passage of the locking part 32 through the mounting hole 66 and coming-off prevention performance of the mounting shaft part 14 from the mounting hole 66.

In addition, the heat insulator 10 is arranged such that the main body part 12 covers the right outer side of the right-side connecting rubber 50 in a state mounted to the mount main body 44. Accordingly, the heat insulator 10 suppresses transmission of heat, which is emitted from a heat source such as an engine located on the right side of the mount main body 44, to the connecting rubber 50, which contributes to improving durability of the connecting rubber 50.

Although the embodiments of the disclosure have been described in detail above, the disclosure is not limited to these specific descriptions. For example, the quantity of the mounting shaft parts 14 is not limited to two, but may be only one or may be three or more. Further, the arrangement of the mounting shaft part 14 is not particularly limited, and its extending direction from the main body part 12 is not particularly limited, either.

The protruding direction of the locking part is not particularly limited as long as the locking part protrudes toward the outer circumference. For example, the locking part may also protrude in the up-down direction of the first embodiment. Further, although the pair of locking parts preferably protrude in directions opposite to each other, the pair of locking parts may also protrude in directions that are not strictly opposite directions, such as in orientations differing by 120 degrees in the circumferential direction. The quantity of the locking parts is plural and may also be three or more. The plurality of locking parts may have the same shape as each other or may have different shapes from each other, such as having different lengths in the circumferential direction.

It is possible that the rubber member is not entirely formed of a rubbery elastic body. For example, a hard reinforcement plate formed of metal or resin may be embedded and fixed in the main body part 12, or a hard core material may be embedded and fixed in the mounting shaft part 14 to stabilize the shape when pressing into the mounting hole 66.

Further, it is also possible to perform two-color molding with different materials on the main body part 12 and the mounting shaft part 14. Accordingly, for example, it is possible to respectively enhance mutually different performances required for each part, such as setting, for the mounting shaft part 14, a rubber hardness capable of realizing workability of insertion into the mounting hole 66 and coming-off prevention performance, while adopting a material with excellent heat resistance for the main body part 12.

The groove-shaped recess 30 is not necessarily limited to an annular recess that is continuous over the entire circumference, and may also be provided partially in the circumferential direction at the base side of the plurality of locking parts 32 and 32.

The mounting rubber member for a vehicle according to the disclosure is not limited to the heat insulator 10 shown in the first embodiment, and may also be, for example, a buffer rubber (bound stopper) shown in Japanese Patent Application Laid-Open No. 2005-249062, a cover rubber that prevents rain and mud from falling, and a soundproofing rubber cover, or may also be a vibration damping rubber composed of a composite rubber including another member such as metal. Further, the mounting rubber member is not necessarily mounted only with the mounting shaft part to the mounting target member, and, for example, it is also possible to provide a locking mechanism such as a hook structure in parallel or auxiliarily adopt fixing by bonding or adhesion for use in combination. Further, considering the possibility of breakage of the mounting shaft part, it is also possible to adopt a fail-safe mechanism that connects the heat insulator to the engine mount for use in combination.

The mounting target member to which the mounting rubber member is mounted is not necessarily limited to a component of the engine mount. For example, the mounting target member may also be a component of a vibration damping device such as a differential mount, a body mount, a subframe mount, and a suspension bush, or may also be various components such as auxiliary devices and structural materials for vehicles other than vibration damping devices. In particular, the disclosure may be applied to a mounting rubber member for a vehicle that is mounted to a mounting target member placed in a situation where it is difficult for a worker to put his or her hand to the back surface side. Further, the specific structure of the mount main body 44 shown in the first embodiment is simply illustrative and is not limiting in any aspect. Specifically, for example, the mount main body may also be a tubular vibration damping device as shown in Japanese Patent Application Laid-Open No. 2005-249062, may also be a bowl-shaped vibration damping device as shown in Japanese Patent Application Laid-Open No. H6-129479, or may also be a fluid-filled vibration damping device as shown in Japanese Patent Application Laid-Open No. H6-129479.

What is claimed is:

1. A mounting rubber member for a vehicle, which is mounted to a surface of a mounting target member of a vehicle, the mounting rubber member for a vehicle comprising:
a mounting shaft part that protrudes toward a mounting direction from a mounting surface overlapped with the surface of the mounting target member and is inserted into a mounting hole of the mounting target member, wherein
the mounting shaft part comprises a neck part that is to be positioned inside the mounting hole of the mounting target member,
the mounting shaft part comprises, in a circumferential direction, a plurality of locking parts that protrude on an outer circumferential surface and are locked to a back surface at a portion that protrudes from the mounting hole of the mounting target member to a back surface side, and
the neck part is formed with a groove-shaped recess that extends in the circumferential direction on a base side of the locking part.

2. The mounting rubber member for a vehicle according to claim 1, wherein the groove-shaped recess is continuously provided over an entire circumference.

3. The mounting rubber member for a vehicle according to claim 1, wherein the mounting shaft part is provided with a portion of the neck part that is off the groove-shaped recess and has a diameter larger than that of an insertion tip part located on a tip side of the locking part.

4. The mounting rubber member for a vehicle according to claim 1, wherein in a longitudinal section at a position at which the locking part is provided, the groove-shaped recess has an area that is recessed toward an inner circumference more inward than the mounting hole and is set to be 60% or more of an area of a portion of the locking part that protrudes toward an outer circumference more outward than the mounting hole.

5. The mounting rubber member for a vehicle according to claim 1, wherein the groove-shaped recess has a groove width dimension that is set within a range of 60 to 150% with respect to a protrusion height dimension of the locking part from the outer circumferential surface of the mounting shaft part.

6. The mounting rubber member for a vehicle according to claim 1, further comprising a pressing operation part to which an external force for inserting the mounting shaft part into the mounting hole is applied, the pressing operation part being integrally formed on an axial extension of the mounting shaft part on a base side of the mounting shaft part.
